(19) United States
(12) Patent Application Publication
(10) Pub. No.: US 2009/0242464 A1
(43) Pub. Date: Oct. 1, 2009

(54) MAIL FEEDER AUXILIARY PADDLE

(76) Inventors: Andrew M. Stubleski, Columbia, MD (US); Pierre J. Campagnolle, Elkridge, MD (US); Laurent Buffat, Columbia, MD (US)

Correspondence Address: SNELL & WILMER L.L.P. (Grumman), 600 ANTON BOULEVARD, SUITE 1400, COSTA MESA, CA, 92626, US

(21) Appl. No.: 12/059,716

(22) Filed: Mar. 31, 2008

(51) Int. Cl. B07C 5/00

(52) U.S. Cl. 209/509

(57) ABSTRACT

A mail sorter including a conveying surface and a main paddle movably disposed on a slide member for supporting a first end of a main stack of mail pieces while traversing along the conveying surface to apply a first stacking pressure to the mail pieces. An auxiliary paddle is also disposed on the slide member for segregating an auxiliary stack of mail pieces from the main stack of mail pieces. The auxiliary paddle is moveable between a first position where the auxiliary paddle is free of contact with any of the mail pieces and a second position where the auxiliary paddle supports the auxiliary stack of mail pieces against the main paddle to apply a second stacking pressure to the auxiliary stack of mail pieces, the second stacking pressure being less than the first stacking pressure.

### BACKGROUND

1. Field

The present invention relates to an apparatus for feeding flat articles to a sorter, and in particular, feeding flat mail items to a mail processing machine such as a mail sorter.

2. Related Art

Machines for receiving and sorting massive volumes of mail pieces are known. Typically, such machines are adapted to receive large volumes of flat mail pieces and stack the flat mail pieces upon selected criteria.

A common problem that occurs when attempting to convey stacks of flat mail pieces is the inability to maintain the integrity of the stack quality. Quite often flat mail pieces require adjusting, including removing, justifying, re-facing and the like in order to keep the stacked articles moving unimpeded through the mail sorting process. Difficulty, is encountered in maintaining stack integrity while trying to transfer a stack of flat mail pieces as well.

Thus, there is a need to convey and transfer a plurality of stacks of flat mail pieces while being able to adjust the stack to maintain the integrity of the stack quality.

### SUMMARY

The present invention includes a mail sorting machine for stacking a plurality of flat mail pieces. In the present invention, the flat mail pieces may be adjusted so as to maintain the integrity of the stack quality as the stacks of flat mail pieces are conveyed and transferred.

In one aspect of the invention, the invention includes a conveying surface and a main paddle movably disposed on a slide member for supporting a first end of a main stack of mail pieces while traversing along the conveying surface to apply a first stacking pressure to the mail pieces. An auxiliary paddle is also disposed on the slide member for segregating an auxiliary stack of mail pieces from the main stack of mail pieces.

The auxiliary paddle is moveable between a first position where the auxiliary paddle is free of contact with any of the mail pieces and a second position where the auxiliary paddle supports the auxiliary stack of mail pieces against the main paddle to apply a second stacking pressure to the auxiliary stack of mail pieces, the second stacking pressure being less than the first stacking pressure.

The present invention provides an improved ergonomic design that creates consistent throughput, by allowing a mail sorter operator to groom mail pieces using both hands. The present invention also provides several advantages to sorting and stacking accuracy by creating improved mail stack quality and improved mail processing/feeding capabilities.

The foregoing and other features and advantages of the invention will become more apparent from the following detailed description, which proceeds with reference to the accompanying figures.

### BRIEF DESCRIPTION OF THE DRAWINGS

The features, objects, and advantages of the invention will become more apparent from the detailed description set forth below when taken in conjunction with the drawings, wherein:

FIG. 1 is a simplified perspective view of a flat mail sort machine;

FIG. 2 is a is a simplified perspective view of a flat mail sort machine configured with an auxiliary paddle in accordance with an embodiment of the present invention; and

FIGS. 3A-3D are simplified perspective views of an operational sequence for the flat mail sort machine of FIG. 2 in accordance with an embodiment of the present invention.

### DETAILED DESCRIPTION

The following description is exemplary in nature and is not intended to limit the scope, applicability, or configuration of the invention in any way. Various changes to the described embodiments may be made in the function and arrangement of the elements described herein without departing from the scope of the invention.

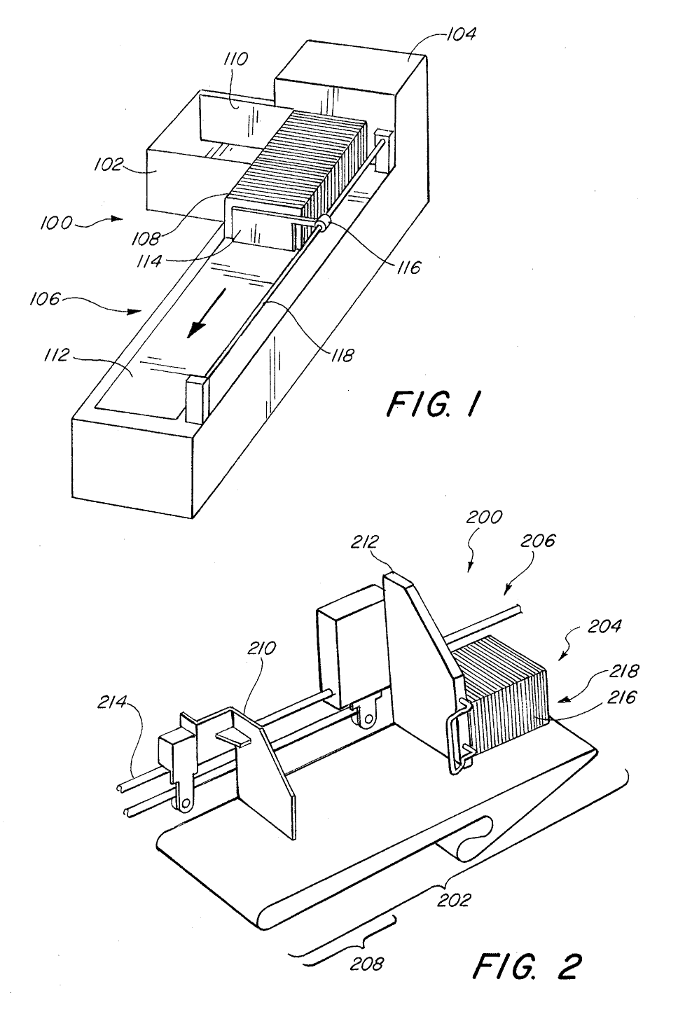

FIG. 1 is a simplified illustration of a typical flat mail sort machine 100. Sort machine 100 may include a mail piece input device 102, an incoming mail piece moving device 104 and a stacking section 106. Stacking section 106 supports a stack of mail pieces 108. An incoming mail piece 110 enters stacking section 106 from mail piece input device 102 into the bottom of mail piece stack 108. As more mail pieces 110 are added to the bottom, mail piece stack 108 expands or grows toward the downstream end of stacking section 106. The continued expansion of mail piece stack 108 creates an increase in pressure on the incoming mail pieces 110. The pressure is relieved using a continuous conveyor belt 112 which spaces out stacked mail pieces 108. A paddle 114 is used to support mail piece stack 108 while traversing down conveyor belt 112, preventing the top mail pieces of the stack 20 from falling toward the downstream end. To facilitate the movement of paddle 114, the paddle may be coupled to a bearing collar 116, which is movably mounted over a shaft or support rod 118, fixed substantially parallel to the moving direction.

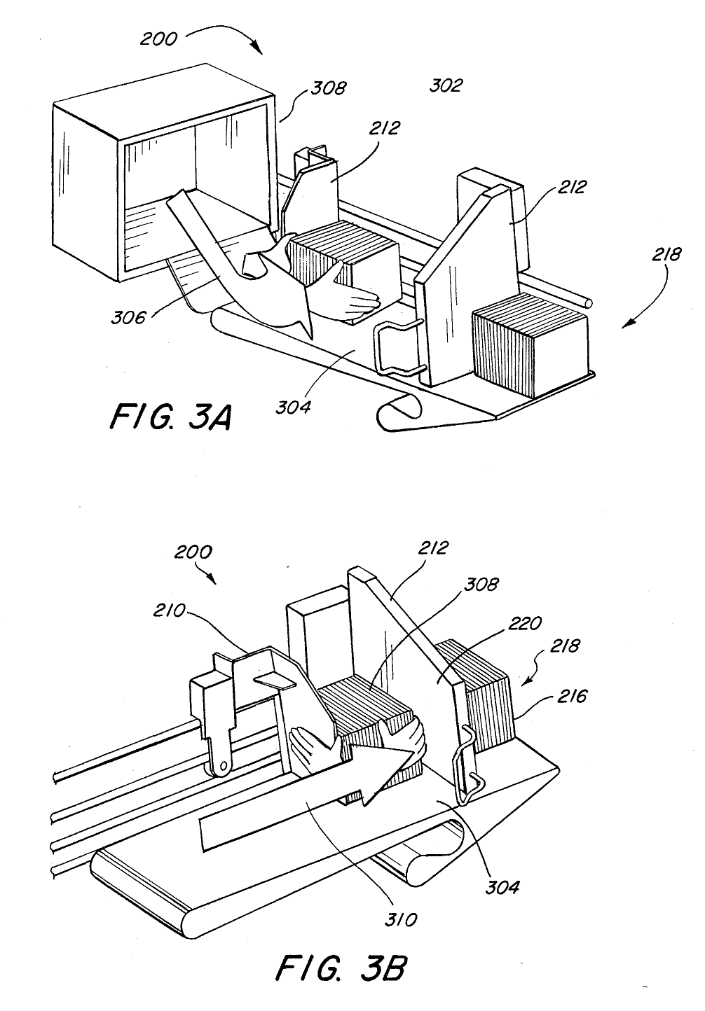

FIG. 2 is a simplified perspective view of a flat mail sort machine 200 including a magazine section 202, a singulation section 204 and an exit section 206. In accordance with the present invention, magazine section 202 includes a conveying surface 201, and a waiting area 208 located at the beginning of magazine section 202, and is configured with an auxiliary paddle 210 and a main paddle 212 in accordance with an embodiment of the present invention. Mail pieces 216 move in a main stack 218 along conveying surface 201.

In one embodiment, auxiliary paddle 210 operates within magazine section 202 of flat mail sort machine 200, and more particular between waiting area 208 and backside 220 of main paddle 212, to support an auxiliary stack of mail pieces 216 along with main paddle 210, which allows an operator an easier opportunity to adjust mail pieces 216.

Auxiliary paddle 210 may be manually moved forward along, for example, a support slide or linear bearing shaft 214, to adjust for varying quantities of mail pieces 216 in the auxiliary stacks as described below. Once removed from waiting area 208, the operation and movement of auxiliary paddle 210 is operationally coupled to main paddle 212. That is, in one embodiment, auxiliary paddle 210 may be driven by the same drive mechanism as main paddle 212. Thus, the movement of auxiliary paddle 210 may be variable relative to the position of main paddle 212. In one embodiment, the drive mechanism may include any well known linear drive mechanism, for example, a #40 ANSI roller chain and sprocket driven by a gear motor assembly (not shown).

As described in greater detail below, creation of auxiliary stacks of mail pieces 216 allows an operator to make corrections to mail pieces 216 in main stack 218 by enabling the operator to change the position of one or some of mail pieces 216 not correctly stacked or faced, prior to be placed in main stack 218. Manipulation of mail pieces 216 is made easier since the use of auxiliary paddle 210 lowers the pressure on mail pieces 216 while in the auxiliary stack to a greater degree than the pressure in main stack 218. While main stack 218 is feeding, the operator has both hands available to correct the auxiliary stack. Since main stack 218 continues to be fed, the operator's efforts to correct mail pieces 216 in the auxiliary stack does not impact on the performance parameters of mail sorter 200, such as throughput, pickoff, doubles and the like.

In accordance one embodiment, auxiliary paddle 210 may be used as an additional paddle that moves generally consistent with main paddle 212 to provide separation between main stack 218 of mail pieces 216 and an auxiliary stack of mail pieces.

In another embodiment, auxiliary paddle 210 may operate in at least two positions where it is either engaged or disengaged from main paddle 212. In this embodiment, auxiliary paddle 210 automatically returns, either through a spring/tension or motorized drive mechanism, as soon as main paddle 212 is raised to release main stack 218. Raising main paddle 212 disengages both paddles 210 and 212 from the drive mechanism, and allows auxiliary paddle 210 to return to a parked position in waiting area 208. When main paddle 212 is lowered, main paddle 212 re-engages with the drive mechanism, and auxiliary paddle 210 can be repositioned relative to main paddle 212, either manually or automatically.

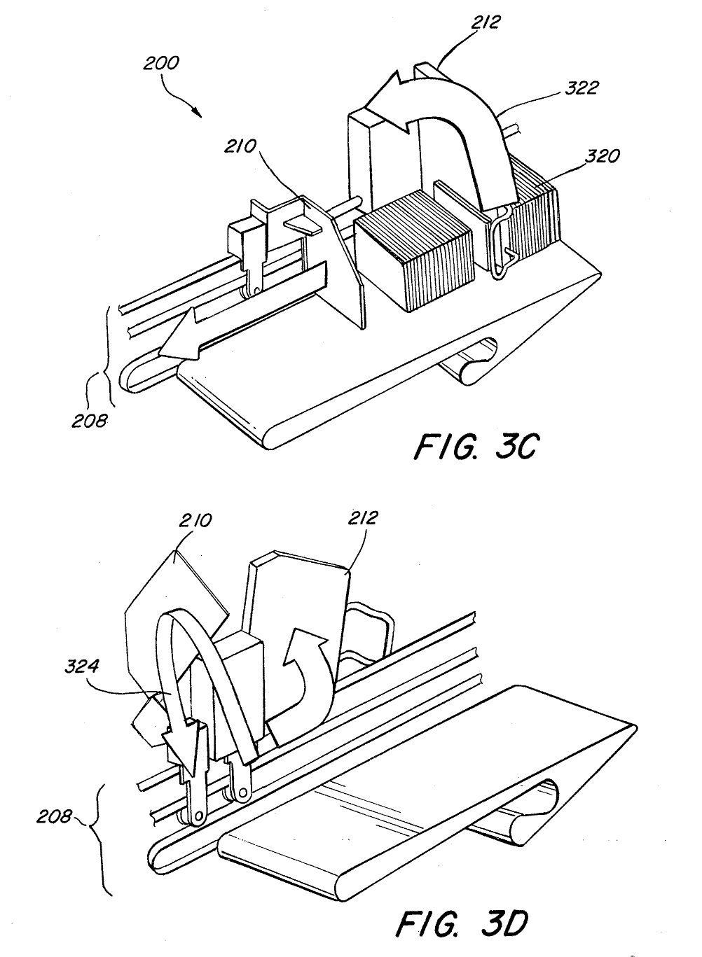

FIGS. 3A-3D are simplified perspective views of one operational sequence of flat mail sort machine 200 in accordance with an embodiment of the present invention. As shown in FIG. 3A, the operator grabs a mail stack 302 of mail pieces 216 from a tray or other container (not shown) and loads mail stack 302 onto feeder ledge 304 in-one motion (1^{st} motion 306). The operator places mail stack 302 between main paddle 212 and auxiliary paddle 210. Auxiliary paddle 210 is positioned so that it holds the entire amount of mail pieces 216 from the mail stack 302. When mail stack 302 is being supported by auxiliary paddle 210 it becomes an auxiliary stack 308. Also, when in this position, auxiliary paddle 210 assists the operator by holding auxiliary stack 308 in position, providing the operator use of both hands to justify or face any misaligned or else remove or repair any bent, curled, nested, skewed, misfaced, or damaged mail pieces 216.

As shown in FIG. 3B, when the operator has completed the adjustment of auxiliary stack 308 to improve the stack quality, the operator may then merge auxiliary stack 308 into main stack 218. Merging of main stack 218 and auxiliary stack 308 may be initiated by moving (2^{nd} motion 310) auxiliary paddle 210 toward main paddle 212, which causes auxiliary stack 308 to be forced up against the backside 220 of main paddle 212. Auxiliary paddle 210 provides support to hold auxiliary stack 308 against backside 220 of main paddle 212.

The operator has both free hands to further groom mail pieces 216 one final time before actually merging main stack 218 and auxiliary stack 308. With auxiliary paddle 210 is in this position, the operator may begin justifying, removing, repairing or re-facing mail pieces 216 since auxiliary stack 308 experiences a lower pressure then main stack 218. Moreover, since auxiliary paddle 210 and main paddle 212 segregate auxiliary mail stack 308 during this intervention, the operator's handling of mail pieces 216 in auxiliary stack 308 does not negatively influence main stack 218. It is known that at this juncture in any mail feeding process, improper handling of main stack 218 may have a detrimental effect on feeder performance.

As shown in FIGS. 3C and 3D, main paddle 212 may be raised to allow auxiliary stack 308 and main stack 218 to be combined into a new main stack 218. Raising main paddle 212 (3^{rd} motion 322) causes auxiliary paddle 210 to become disengaged from the drive mechanism. Auxiliary paddle 210 may then return (manually or automatically, motion 324) to waiting area 208. When parked, main paddle 212 has no affect on the movement of auxiliary paddle 210.

The invention has been disclosed in an illustrative manner. Accordingly, the terminology employed throughout should be read in an exemplary rather than a limiting manner. Although minor modifications of the invention will occur to those of ordinary skill in the art, it shall be understood that what is intended to be circumscribed within the scope of the patent warranted hereon are all such embodiments that reasonably fall within the scope of the advancement to the art hereby contributed, and that scope shall not be restricted, except in light of the appended claims and their equivalents.

What is claimed is:

1. A mail sorting machine for stacking a plurality of mail pieces comprising:
a conveying surface;
a main paddle movably disposed on a slide member for supporting a first end of a main stack of mail pieces while traversing along said conveying surface to apply a first stacking pressure to said mail pieces; and
an auxiliary paddle disposed on the slide member for segregating an auxiliary stack of mail pieces from said main stack of mail pieces to apply a second stacking pressure to said auxiliary stack of mail pieces.

2. The mail sorting machine of claim 1, wherein said second stacking pressure is less than said first stacking pressure.

3. The mail sorting machine of claim 1, wherein said auxiliary paddle is moveable between an engaged position where movement of the auxiliary paddle is dependent on movement of the main paddle and a disengaged position where movement of the auxiliary paddle is independent of the movement of the main paddle.

4. The mail sorting machine of claim 3, wherein said main paddle is rotatable about said slide member perpendicular to said conveying surface, and wherein rotation of the main paddle causes said auxiliary paddle to return to the disengaged position.

5. The mail sorting machine of claim 1, wherein said slide member comprises a linear rod, and said main paddle is rotatable about said slide member perpendicular to said conveying surface.

6. The mail sorting machine of claim 1, wherein said slide member comprises a linear rod, and said auxiliary paddle is rotatable about said slide member perpendicular to said conveying surface.

7. The mail sorting machine of claim 1, wherein said auxiliary paddle is moveable between a parked position wherein said auxiliary paddle is free of contact with any of said mail pieces and a deployed position wherein said auxiliary paddle supports said auxiliary stack of mail pieces against said main paddle.

8. The mail sorting machine of claim 1, further comprising a drive mechanism which creates a linear motion of said main paddle and said auxiliary paddle along said conveying surface when in said engaged position.

9. The mail sorting machine of claim 1, wherein the conveying surface comprises a belt type conveyor.

10. A mail sorting machine for stacking a plurality of mail pieces comprising:
a conveying surface including a belt type conveyor;
a main paddle movably disposed on a slide member for supporting a first end of a main stack of mail pieces while traversing along said conveying surface to apply a first stacking pressure to said mail pieces; and
an auxiliary paddle disposed on the slide member for segregating an auxiliary stack of mail pieces from said main stack of mail pieces, said auxiliary paddle moveable between a first position where said auxiliary paddle is free of contact with any of said mail pieces and a second position where said auxiliary paddle supports said auxiliary stack of mail pieces against said main paddle to apply a second stacking pressure to said auxiliary stack of mail pieces, said second stacking pressure being less than said first stacking pressure.

11. The mail sorting machine of claim 10, wherein movement of the auxiliary paddle is dependent on movement of the main paddle when in said second position and movement of the auxiliary paddle is independent of the movement of the main paddle when in said first position.

12. The mail sorting machine of claim 10, wherein said main paddle is rotatable about said slide member perpendicular to said conveying surface, and wherein rotation of the main paddle causes said auxiliary paddle to return to the first position.

13. The mail sorting machine of claim 10, further comprising a drive mechanism which creates a linear motion of said main paddle and said auxiliary paddle along said conveying surface when in said second position.

14. A method for stacking mail pieces comprising:
supporting a main stack of mail pieces using a main paddle movably disposed on a slide member while traversing along a conveying surface to apply a first stacking pressure to said mail pieces; and
moving an auxiliary paddle from a first position where said auxiliary paddle is free of contact with any of said mail pieces and a second position where said auxiliary paddle supports an auxiliary stack of mail pieces against said main paddle to apply a second stacking pressure to said auxiliary stack of mail pieces.

15. The method of claim 14, wherein said movement of the auxiliary paddle is dependent on movement of the main paddle when in said second position and wherein said movement of the auxiliary paddle is independent of the movement of the main paddle when in said second position.

16. The method of claim 14, further comprising rotating said main paddle perpendicular to said conveying surface to cause said auxiliary paddle to return to the first position.

17. The method of claim 14, wherein said moving comprises driving said auxiliary paddle with a drive mechanism which creates a linear motion of said auxiliary paddle along said conveying surface.

18. The method of claim 14, further comprising adjusting said mail pieces to remove, justify or reface said mail pieces within said auxiliary stack.

19. The method of claim 14, further comprising merging said main stack of mail pieces and said auxiliary stack of mail pieces by rotating said main paddle perpendicular to said conveying surface.

20. The method of claim 14, wherein said second stacking pressure is less than said first stacking pressure.
